(19) United States
(12) Patent Application Publication
(10) Pub. No.: US 2015/0316270 A1
(43) Pub. Date: Nov. 5, 2015

(54) WATER SUPPLY FOR STEAM GENERATOR (AMENDED)

(71) Applicant: MIWE MICHAEL WENZ GMBH, Arnstein (DE)

(72) Inventors: Michael Koos, Arnstein (DE); Bernd Pfeuffer, Obersfeld (DE)

(21) Appl. No.: 14/441,942

(22) PCT Filed: Nov. 6, 2013
(86) PCT No.: PCT/EP2013/073184

§ 371 Date: May 11, 2015

(30) Foreign Application Priority Data
Nov. 14, 2012 (DE) 10 2012 220 812.7
Jul. 24, 2013 (DE) 20 2013 103 331.6

(51) Int. Cl. F24C 15/00; A21B 3/04

(52) U.S. Cl. CPC F24C 15/003; A21B 3/04

(57) ABSTRACT

A steam generator for an oven, includes at least one heat transfer element and at least one water conduit which carries water to the heat transfer element. The system optimizes the targeted introduction of steam into a defined space and the removal thereof from the space. This is achieved by means of at least one pressure increasing device which increases the water pressure, such as e.g. a compressed air line through which compressed air is fed to the water.

The invention relates to a steam generator for generating the baking vapor of a baking oven. The steam generator has at least one heat transfer element and at least one water line which conducts water to the heat transfer element.

Steam generators of this type are used in baking ovens to generate steam vapor which is guided into the baking chamber and advantageously influences the baked result. A plurality of designs of steam generators of this type are known. In a first design, a plurality of heat transfer elements are situated directly in the baking chamber or in a chamber which adjoins the baking chamber and is flowed through by the baking atmosphere. In this case, the heat transfer elements are frequently steam iron elements, that is to say elongate, bar-shaped metal elements, of which a plurality are arranged one above another. The water is either applied to the individual steam iron elements or flows in a cascade-like manner over the steam iron elements from the top to the bottom. In the process, it absorbs the heat of the steam iron elements and evaporates. The heat transfer elements themselves are heated either by the baking atmosphere or by other hot media, such as the exhaust gas of the burner of the baking oven.

A baking oven of this type with steam iron elements is known, for example, from the document DE 10 2008 035 394 B3. Here, the vapor apparatus is heated by an exhaust gas duct for the burner exhaust gas and is situated on the rear wall of the baking chamber.

Furthermore, vapor apparatuses are known which are arranged in external chambers which are separate from the baking chamber. Said chambers are filled almost completely with metal and have separate heating elements, for example coils which are flowed through by thermal oil, which heating elements heat up the heat transfer elements and also themselves serve to transfer heat to the water. Steam generators of this type for baking ovens are known, for example, from the document DE 10 2005 058 592 A1 and from the document DE 10 2008 041 412 A1.

Other steam generators utilize the advantage of finer atomizing of a water quantity which is applied to a rotating body. This principle is described, for example, in the document EP 0 244 538 A2, in which the rotating body is arranged within the fan. Other embodiments are known, in which the water is applied directly to the fan of the oven. As a result of the rotational movement, the water is flung off from the rotating body in fine droplets. During this operation, the rotating fan circulates the air, with the result that the intensive contact of the steam vapor with the baked goods surface is disrupted by the air movement, as a result of which the baked result is influenced negatively.

It is an object of the present invention to optimize the targeted introduction and removal of steam into a predefined chamber, in particular the introduction and removal of baking vapor into and from a baking chamber.

In relation to a steam generator, this object is achieved by way of the features of claim 1. The subclaims which refer back to claim 1 contain advantageous embodiments of the invention.

A steam generator for a baking oven is proposed having at least one heat transfer element and having at least one water line which conducts water to the heat transfer element, a pressure increasing apparatus increasing the pressure of the water.

The water exits through spray nozzles in the region of the steam generator. As a result of the pressure increase of the water, its outflow speed from the spray nozzles is increased and, as a result, the atomization of the water is improved.

In a first embodiment of the steam generator, the steam generating apparatus can be a pump which is connected to the water line. The pump increases the static pressure of the water which is removed from the supply network, with the result that said water exits from the spray nozzles at an increased speed. In practice, the pump can be electrically driven and can be fed with power via a power supply of the baking oven.

As an alternative or in addition, at least one compressed air line can be provided, by way of which compressed air is added to the water.

The compressed air in the compressed air line has a pressure which preferably lies considerably above the pressure of the water in the water line. For example, a pressure of the air in the compressed air line of approximately 1 bar above ambient pressure can be selected. However, the pressure of the air can vary and can also be adjustable by way of a solenoid valve if required. Water flows at a lower positive pressure from the water outlet openings of the water line. The compressed air is added to the water before said water flows out or while said water flows out of outflow openings of the water line. As a consequence, the water which flows out of the openings of the water line flows at a very much higher speed from the openings. The compressed air causes the water which flows out of the openings of the water line to exit the openings in the form of a spray mist. As a consequence, the water strikes the surface of the heat transfer element in the form of very fine droplets. Only a small amount of thermal energy is necessary to evaporate the very fine droplets. As a result, the heat transfer elements cool to a lesser extent when sprayed with the finely distributed water droplets than when a conventional water jet is applied.

As a result of the measure of finely atomizing the water with compressed air, a very satisfactory baking vapor can be generated in a short time with a smaller water quantity and with less cooling of the heat transfer elements, with the result that less heating energy has to be used for the steam generation with the same baking result and the baking time can even be reduced.

It goes without saying that a combination consisting of a pump and of a compressed air line can also be provided on the water line, in order to increase the water pressure.

In practice, the compressed air line can open into the water line. The water line usually has a plurality of openings and the pressurized water exits at all these openings together with the compressed air in the form of a spray mist or a spray of finely distributed water droplets. The high air pressure can generate a high flow speed in the water line, with the result that the entire flow has a high dynamic and relatively low static pressure. In this way, in a similar manner to the principle of a Venturi nozzle, the water is conveyed into the water line on account of the low static pressure and is driven along by the air flow, with the result that it exits from the openings of the water line as a fine mist. Any other desired combinations of water and compressed air are also possible. Thus, for example, the compressed air can be guided separately from the water to the openings in the water line and can entrain water there on account of the Venturi effect.

In particular in the case of a vapor apparatus with a plurality of steam iron elements, a plurality of spray openings which are arranged at spacings from one another can be arranged in the water line. Here, one spray opening can be provided in each case between two steam iron elements.

In steam generators which are arranged in a separate chamber and the steam of which is guided via steam ducts into the baking chamber, the water line can be provided with only one or a few spray openings which are arranged, for example, at the end of the water line.

In practice, the water line can be connected to a supply system, and a non-return valve can be arranged in the water line between the opening of the compressed air line and the connector to the supply system. This avoids a situation where the water is pressed back into the supply system as a result of the increased pressure of the compressed air. The entire compressed air escapes with the water through the spray openings of the water lines and conveys water droplets to the heat transfer elements. The introduction of the compressed air can also take place at intervals when the back-pressure of the compressed air in the water line blocks a supply of water. As a result of the compressed air supply being switched off temporarily, the overall pressure in the water line is reduced and water can flow in.

In one embodiment, the water line can be arranged substantially horizontally and above the heat transfer elements. This configuration is preferably selected for separate steam generators which are arranged in chambers which are separate from the baking chamber.

As an alternative, the water line can run substantially vertically and laterally with respect to the heat transfer elements. This arrangement is preferably selected in vapor apparatuses with steam iron elements in the baking chamber or a chamber which adjoins the baking chamber.

The compressed air line is to be connected to a compressed air source. If a compressed air supply system which is fed by a compressor is situated in the bakery, in which the baking oven and the associated steam generator are operated, said compressed air supply system can be used as compressed air source. If this is not the case, the compressed air line can be connected to a compressed air cylinder, from which the compressed air is removed. As an alternative, a compressor, optionally with a compressed air accumulator, can be arranged in the baking oven or in its immediate vicinity, which compressor is connected to the compressed air line, in order to feed in compressed air.

The heat transfer elements can be any desired heating devices or heatable elements. If the steam generator is used with a baking oven, a heater is already provided for the baking oven. In this case, the heat transfer elements can be simple metal bodies for storing heat, which metal bodies are heated up by the baking oven heater. In particular, the heat transfer elements can be heatable metal bodies, such as metal bars, metal elements which are connected movably to one another, in particular links of an iron chain or steam iron elements.

In the case of small baking ovens, for example in-store baking ovens, the baking vapor can be generated simply by way of the introduction of water into the baking chamber, without the water being applied onto special heat-accumulating bodies or special heating apparatuses. The simple spraying of the finely atomized water into the hot baking atmosphere will lead to the evaporation of the water. If the water does not evaporate completely in the atmosphere which is heated by way of the heating elements of the baking oven, the fine water mist strikes a hot surface of the baking chamber or a structural element in the baking chamber and evaporates there. The fan of the oven does not have to rotate during this operation, with the result that the steam vapor is produced in the stationary atmosphere and can wet the baked goods as intended.

In practice, the above-described steam generator can be an integrated constituent part of a baking oven. To this end, it can be integrated directly into the baking chamber or can be arranged in a separate chamber of the baking oven, which are connected via steam ducts to the baking chamber. In particular, the heat transfer elements and therefore also the water lines can be arranged either in the baking chamber or in a chamber which adjoins the baking chamber or in a remote chamber in the or on the baking oven, which chambers are connected to the baking chamber via steam ducts.

The above-described steam generator is preferably used in a method for generating baking vapor, in which method water is supplied to at least one heat transfer element via at least one water line, and the water vapor which is produced is guided into a baking chamber, air being added to the water pressure.

However, the above-described compressed air line can also be used to remove vapor from a baking oven. In a method of this type for removing baking vapor, in the case of the steam generator which is connected to the baking chamber and has at least one water line and at least one compressed air line, the water supply to the water line is shut off and the compressed air supply to the compressed air line is opened. As a result of the compressed air, a positive pressure is produced in the baking chamber, which positive pressure drives the baking atmosphere out of the baking chamber. Here, the moisture which is situated in the baking chamber is removed from the baking oven rapidly. This rapid removal of vapor makes conventional vapor removing techniques, such as the opening of fresh air flaps, unnecessary. The vapor flows out of the baking chamber via the normal positive pressure ducts. As a result of these vapor removal methods, the construction of the oven can even be simplified by omission of the fresh air flap.

Exemplary embodiments will be described in the following text with reference to the appended drawings, in which:

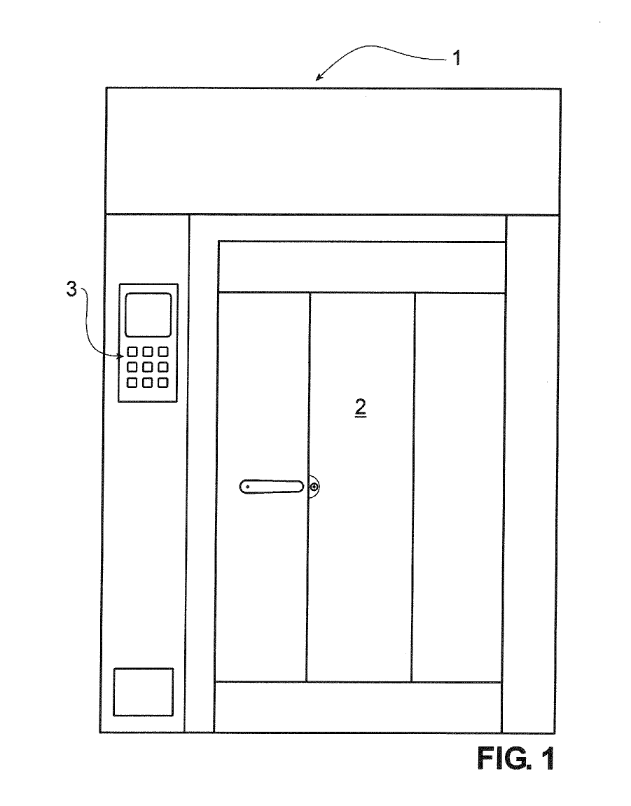

FIG. 1 shows a front view of a baking oven with a vapor apparatus.

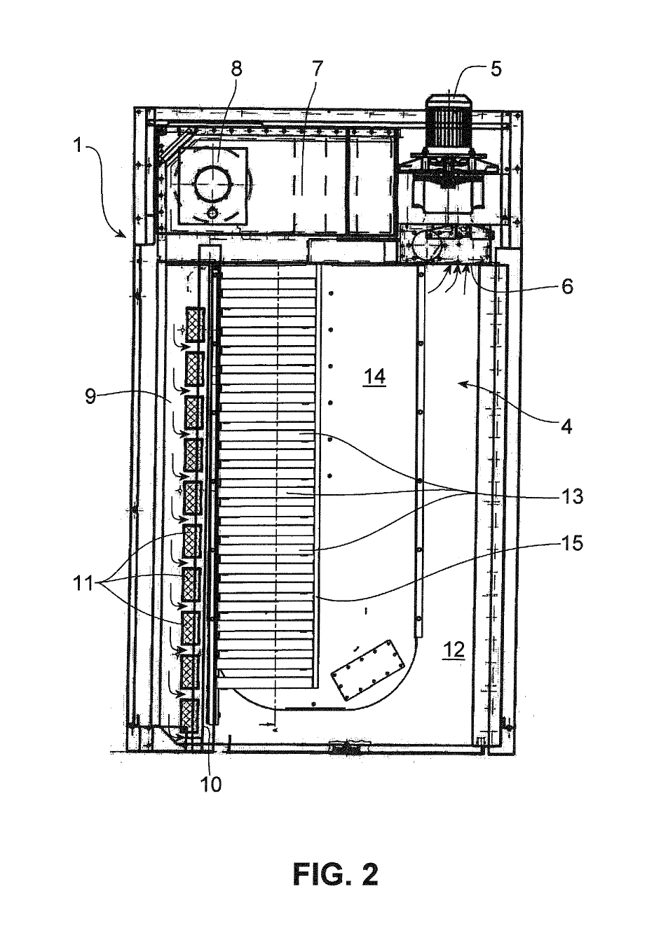

FIG. 2 shows a sectioned illustration of the baking oven from FIG. 1 with a view of the rear wall.

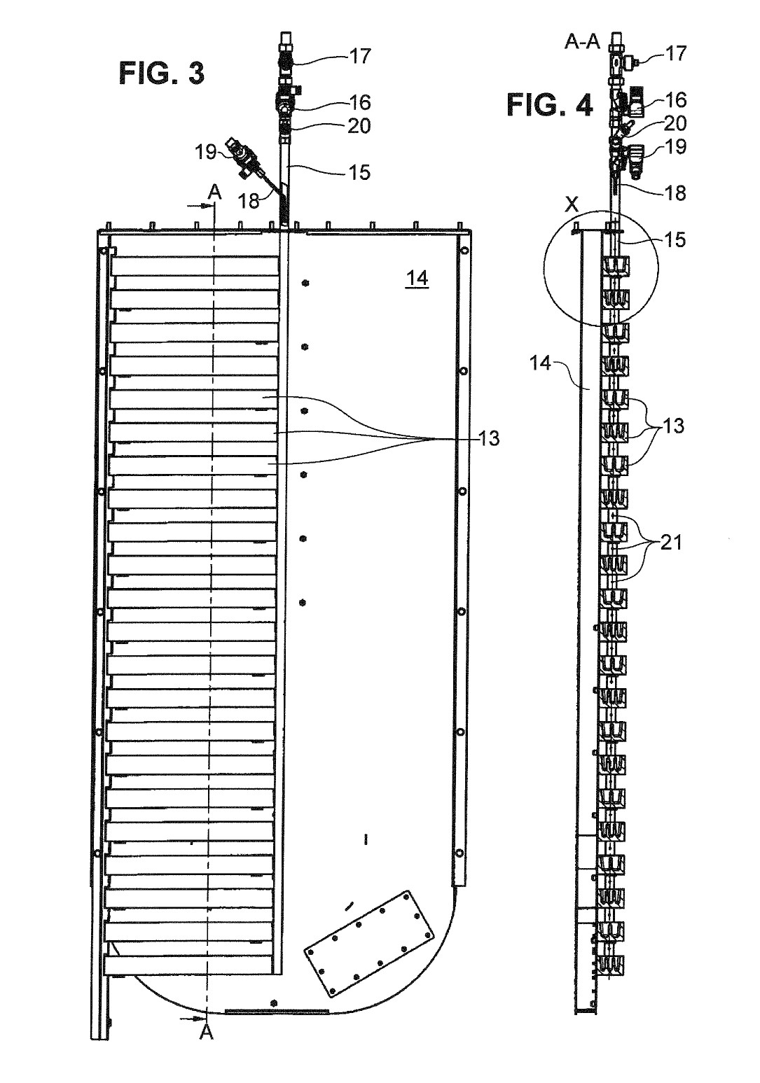

FIG. 3 shows the vapor apparatus of the baking oven from FIGS. 1 and 2.

FIG. 4 shows a sectional view of the vapor apparatus from FIG. 3 according to sectional line A-A.

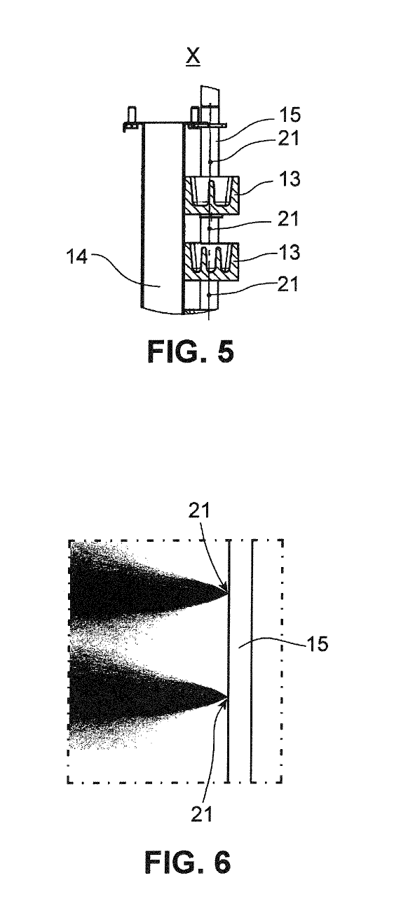

FIG. 5 shows the enlarged detail X from FIG. 4.

FIG. 6 shows a spray profile of the water line of the vapor apparatus from FIGS. 3 to 5.

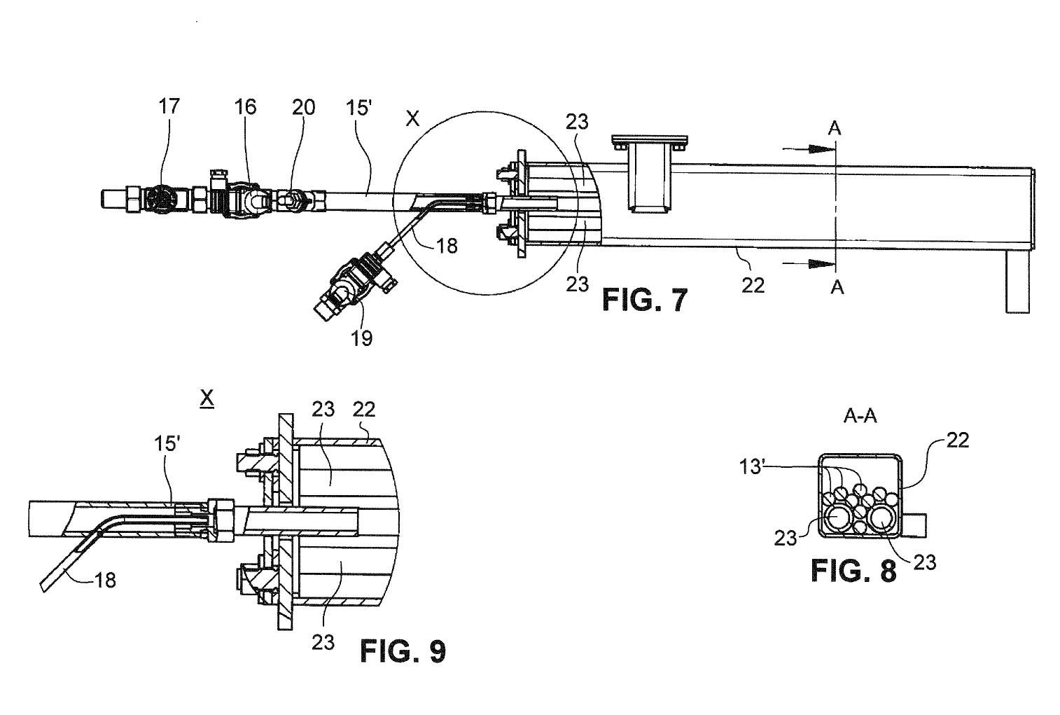

FIG. 7 shows an alternative embodiment of a vapor apparatus in a side view.

FIG. 8 shows the vapor apparatus from FIG. 7 in an illustration which is sectioned along sectional line A-A.

FIG. 9 shows an enlarged illustration of the detail X of the vapor apparatus from FIG. 7.

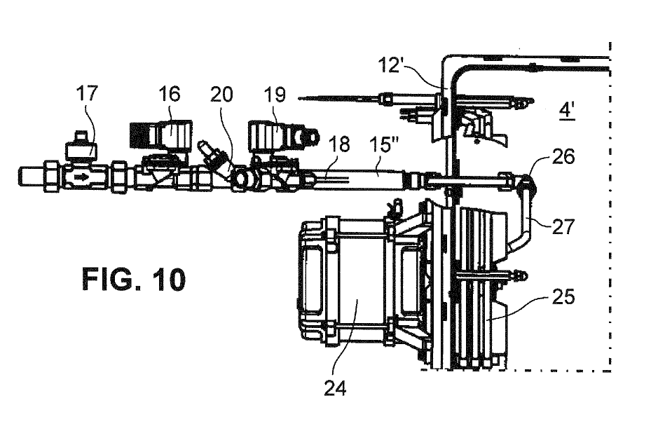

FIG. 10 shows a sectioned side view of a further embodiment of a baking oven with a novel steam generator.

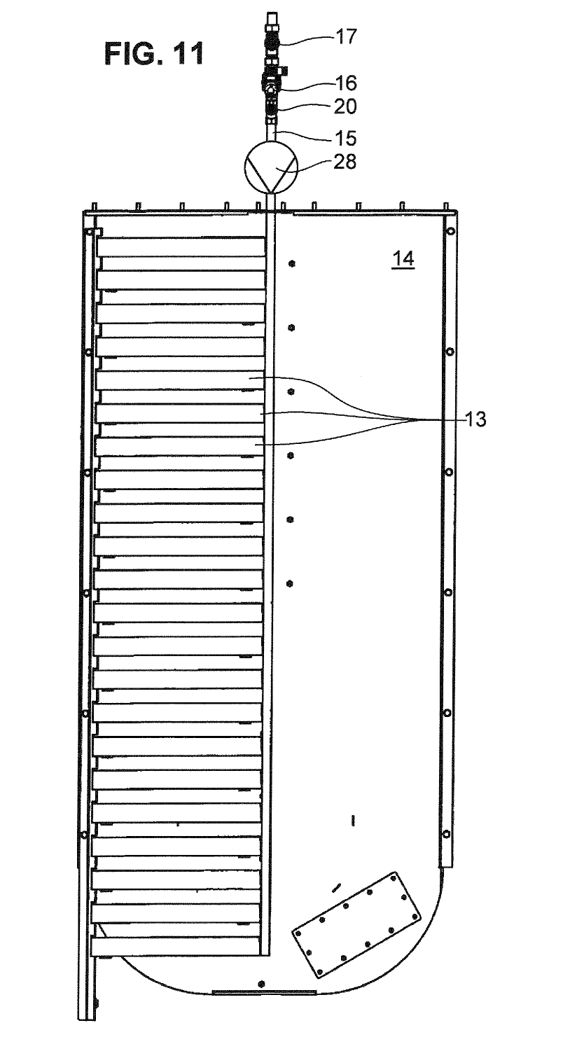

FIG. 11 shows an illustration, corresponding to FIG. 3, of the vapor apparatus of the baking oven, in which vapor apparatus a pump is provided to increase the water pressure instead of a compressed air line.

FIG. 1 shows a baking oven which is usually used in bakeries or in baked goods factories. The baking oven comprises a housing 1 with a door 2 which is closed during the baking operation and can be opened for introducing and removing the baked goods. The door 2 is approximately two meters high and reaches without a door sill as far as the floor. This ensures that a baking trolley (also called rack trolley) can be pushed into the baking chamber of the baking oven through the door opening when the door 2 is open. Furthermore, an operating panel 3 with a display screen can be seen in FIG. 1. Parameters of the baking operation (for example, duration, temperature, vapor supply) can be input via the operating panel 3, which parameters are subsequently displayed for control purposes via the display screen of the operating panel 3.

FIG. 2 shows a sectional illustration of the baking oven from FIG. 1, in which the front side with the door is cut away. The cross section of the baking space 4 (also called bake chamber) and the essential functional elements which are required for the baking operation can be seen. A fan 5 can be seen at the top right in the housing 1 of the baking oven. Said fan 5 sucks a heating medium which usually consists of heated air out of the baking chamber 4 through its top wall 6. A throttle or slide can be provided in the region of the top wall 6, in order to vary the flow cross section for the extracted heating medium and thus to influence the thermal quantity fed to the baked goods in the baking chamber 4.

From the fan 5, the heating medium flows through a heating coil 7 which is heated by a burner 8. The burner 8 is usually operated using oil or gas. The air which is heated in this way subsequently flows into a supply duct 9 which is situated in that section of the oven housing 1 which is shown on the left-hand side in FIG. 2. The supply duct 9 extends over the entire height of the baking chamber 4 and adjoins its left-hand side wall 10. Elongate refractory bricks 11 are arranged in the supply duct 9 directly next to the left-hand side wall 10. Said refractory bricks 11 are heated by the heated heating medium to its temperature. If the heating medium is cooled, for example by opening of the oven door and introduction of new baking goods, the thermal storage capacity of the refractory bricks 11 ensures that the heating medium rapidly reaches the provided temperature again after renewed closure of the oven door. As a consequence, the refractory bricks 11 form heat accumulator elements for heating the heating medium.

The refractory bricks 11 are distributed at a spacing from one another over the height of the left-hand side wall 10 of the baking chamber 4. The gaps between the refractory bricks 11 define the flow path of the heating medium. The left-hand side wall 10 of the baking chamber 4 consists of a metal sheet with apertures which make it possible for the heating medium to enter into the baking chamber 4.

Heat transfer elements 13 are arranged on the rear wall 12 of the baking chamber 4, which rear wall 12 can be seen in FIG. 2. The heat transfer elements 13 are formed by elongate and upwardly open steam iron elements which are explained in greater detail in conjunction with FIGS. 3 to 5. A water line 15 which extends in the vertical direction at the right-hand end of the steam iron elements 13 makes it possible to supply water to the steam iron elements 13. The water line 15 is formed by a distributor pipe made from metal. As a result of water being sprayed onto the steam iron elements 13, steam vapor is generated in the baking chamber 4 which has a positive influence on the baked result.

The steam iron elements 13 are situated on the rear wall of the baking chamber 4 and therefore outside the flow path of the heating medium which flows from the left-hand side wall 10 of the baking chamber 4 to the upper right-hand side of the top wall 6 of the baking chamber. As a consequence, deposits or other changes to the steam iron elements 13 cannot influence the flow of the heating medium through the baking chamber 4.

In order that the steam iron elements 13 maintain the required temperature on the rear wall 12 of the baking chamber 4, they are fastened to a flue gas duct 14 in the region of the rear wall 12 of the baking chamber 4. Unlike, for example, in the case of the vapor apparatuses which are known from DE 10 2008 035 394 B3, the steam iron elements 13 of the present vapor apparatus extend only over half the width of the exhaust gas duct because less thermal storage mass and contact area of the steam iron elements 13 is required to generate the required steam quantity on account of the improved spraying operation.

FIG. 3 shows an isolated illustration of the vapor apparatus on the exhaust gas duct 14 for heating it. FIG. 4 shows the vapor apparatus from FIG. 3 in an illustration which is sectioned along the sectional line A-A. FIG. 5 shows an enlarged view of two steam iron elements from FIG. 4.

It can be seen that the steam iron elements 13 are arranged at a spacing from one another over the height of the exhaust gas duct 14 in the left-hand half thereof. The water line 15 on the right-hand side of the steam iron elements 13 consists of a metallic distributor pipe. The distributor pipe 15 is connected via a solenoid valve 16 to a water supply source, for example a water supply system. The solenoid valve 16 permits the controlled supply of water and the shutting off of water if no steam vapor is to be generated. A water meter 17 is arranged in the region of the solenoid valve 16, which water meter 17 transmits its measured values to the controller for the vapor apparatus of the baking oven, with the result that said controller can determine the quantity of supplied water. It is possible in this way to supply precisely that water quantity in every baking cycle which is necessary for the generation of the required steam vapor.

However, the water supply source can also be pressureless and can consist, for example, of a simple water tank which is arranged somewhat above the water line, with the result that the water flows to the water line on account of atmospheric pressure. The compressed air which flows at high speed through the water line and/or out of the openings of the water line entrains the water and ensures its fine distribution even if there is no considerable water pressure.

Furthermore, a compressed air line 18 opens into the distributor pipe 15 above the steam iron elements 13. The compressed air line 18 is in turn connected via a solenoid valve 19 to a compressed air source (not shown). If the vapor apparatus is operated in a hall, in which there is a compressed air supply system, the compressed air can be conducted directly out of the compressed air supply system via the solenoid valve 19 to the compressed air line 18. If the compressed air line 18 cannot be connected to a compressed air supply system, the baking oven itself can be equipped with a compressed air cylinder or with a compressor which generates the required compressed air.

Water pressure and air pressure can be adjustable by way of both solenoid valves 16 and 19. The water pressure should lie below the air pressure. The selected pressure values for the compressed air lie, for example, approximately at 2 bar total pressure, the water pressure being set via the solenoid valve 16, for example, to approximately 1.5 bar. If the water is not supplied from a supply system, but rather from a tank, the water pressure can also lie close to atmospheric pressure.

The compressed air line 18 penetrates the wall of the distributor pipe 15, the opening in the wall being sealed with respect to the surroundings. For example, the compressed air line 18 can be brazed tightly into the opening in the wall of the distributor pipe 15 or can be inserted tightly into the distributor pipe 15 via another sealing compound.

A non-return valve 20 is arranged on the distributor pipe 15 between the opening of the compressed air line 18 into the distributor pipe 15 and the solenoid valve 19 which connects the distributor pipe 15 to the water supply system. The non-return valve 20 avoids backflow of water from the distributor pipe 15 into the water supply system if a positive pressure is produced in the distributor pipe 15 on account of the compressed air which is added.

As FIGS. 4 and 5 show, the steam iron elements 13 have a substantially W-shaped profile. It can be seen, in particular, in FIG. 5 that a spray nozzle or spray opening 21 which is formed by way of drilling in the distributor pipe 15 is arranged above each steam iron element 13. The diameter of the bores can vary over the length of the distributor pipe 15 depending on the magnitude of the pressure which prevails at the respective bore. The diameter of the bores usually lies between 2 and 8 mm.

FIG. 6 shows the front view of an isolated distributor pipe 15, to which both water and compressed air are supplied. As a result of the increased pressure and the mixing of air into the water in the distributor pipe 15, the water exits the distributor pipe 15 as a spray with very fine droplets in the form of an aerosol. The very fine water droplets wet the steam iron elements 13 on the entire surface thereof if they do not already evaporate in the heated baking atmosphere. Only a small quantity of thermal energy is required, in order to allow the water droplets of the aerosol to evaporate. For this reason, the steam iron elements 13 can be of considerably shorter configuration than in conventional baking ovens. In addition, a smaller water quantity and a smaller amount of heating energy are required, in order to generate the steam vapor which is desired for an optimum steam result.

FIGS. 7 to 9 show another embodiment of a vapor apparatus. Here, the steam vapor is generated in a separate steam chamber which is formed by a housing 22 made from steel sheet. Here, the water line 15′ is formed by an open spray pipe which protrudes some centimeters into the housing 22. A compressed air line is once again provided which opens into the water line 15′ and mixes compressed air into the supplied water. The compressed air line 18 can also be closed by a solenoid valve 19 in this embodiment. As in the preceding embodiment, the water line 15′ is connected to the water supply system via a non-return valve 20, a solenoid valve 16 and a water meter 17.

On account of the compressed air, a fine spray mist of water is sprayed through the open end of the spray pipe 15′, which spray mist extends substantially over the entire length of the housing 22 and is distributed into all regions of the housing 22.

Steel bars 13′ are arranged as heat transfer element in the housing 22. Furthermore, a U-shaped heating pipe 23 is arranged in the housing 22, of which heating pipe 23 in each case sections of the two limbs are visible in the drawings. The heating pipe 23 is flowed through by thermal oil or another heatable fluid and heats up the steel bars 13′. The heating pipe 23 itself also serves as heat transfer element for transferring heat to water which is introduced into the housing 22. The water vapor which is produced in the housing 22 is guided through a steam duct (not shown) into a baking chamber.

The supplied compressed air once again generates a fine spray mist during the introduction of the water, with the result that steam vapor is generated in a very short time in the housing 22 when the water is sprayed in, which steam vapor can be guided into the baking chamber.

For the vapor apparatus from FIGS. 7 to 9, a simple open spray pipe 15′ with a spray mist which exits rectilinearly at the front end is satisfactory. As an alternative, the end of the spray pipe can be closed and can be provided with bores in order to form spray nozzles. The bores can be arranged on the closed end side of the spray pipe or on the circumference of the spray pipe. The size and the direction of the spray mist which is sprayed in can be varied by way of the bores.

This can be advantageous, for example, during the introduction of water directly into a baking chamber without steam iron elements or similar heat accumulator bodies. A baking oven of this type is shown in FIG. 10. FIG. 10 shows the upper and rear section of the baking chamber 4′ with the rear wall 12′ and top wall 6′ of the baking oven housing of an in-store baking oven, as is used in retail businesses, restaurants or at gas stations. A drive motor 24 for a fan rotor is arranged on the outer side of the rear wall 12′. The fan rotor is situated on the inner side of the rear wall 12′ and is covered by the rotor casing 25 in FIG. 10.

The water supply for the steam generation corresponds substantially to the illustration from FIG. 4. Identical designations are used for identical parts. A water meter 17 and a solenoid valve 16 are arranged in a water line 15″. A compressed air line 18 opens into the water line 15″, the compressed air of which compressed air line 18 can be regulated via a solenoid valve 19. A non-return valve 20 prevents the backflow of water into the water line 15″.

Within the baking chamber 4′, the water line 15″ is connected by means of a coupling piece 26 to a deflection pipe 27 which deflects the water and the compressed air downward and rearward, with the result that the spray mist which exits at the opening of the deflection pipe 27 is directed into the rotor casing 25 and toward the rotor and toward the rear wall 12′. The rotor casing 25 and the rear wall 12′ of the baking chamber are heated by the heating apparatus of the baking oven to the baking temperature. The water which is sprayed in fine droplets evaporates when striking the surfaces of the rotor casing 25, the rotor which is situated therein, and the rear wall 12′. Here, rotation of the rotor during the spraying of the water is not required. The reason for spraying in toward the rotor and the rear wall 12′ lies in the fact that direct spraying of the baked goods and pastry in the center of the baking chamber 4′ is to be avoided.

The compressed air line 18 can also be used to drive the steam vapor out of the baking chamber. For this purpose, the solenoid valve 16 which is arranged in the water line 15, 15′, 15″ is shut off. In contrast, the solenoid valve 19 in the compressed air line 18 is opened, with the result that the compressed air flows into the baking chamber 4, 4′ and drives the baking atmosphere which is present there through a positive pressure duct out of the baking chamber. A separate fresh air flap for removing vapor from the baking chamber 4, 4′ is not required. As a result, the structural construction of a baking oven is considerably simplified and the precisely timed removal of the baking vapor from the baking chamber is considerably improved in comparison with a baking oven without a compressed air line 18.

FIG. 11 shows an alternative embodiment of the invention, in which the pressure of the water which is sprayed into the vapor apparatus is increased by means of a pump 28. The pump 28 is arranged in the water line 15. It goes without saying that the compressed air line and the pump 28 for increasing the water pressure can also be combined with one another in alternative embodiments.

The features of the invention which are disclosed in the present description, in the drawings and in the claims can be essential both individually and in any desired combinations for the realization of the invention in its various embodiments.

### LIST OF REFERENCE NUMERALS

1 Housing
2 Door
3 Operating panel
4, 4′ Baking chamber
5 Fan
6, 6′ Top wall
7 Heating coil
8 Burner
9 Supply duct
10 Side wall
11 Refractory brick, heat accumulator element
12, 12′ Rear wall
13 Heat transfer element, steam iron element
13′ Heat transfer element, steel bar
14 Flue gas duct
15 Water line, distributor pipe
15′ Water line, spray pipe
15″ Water line
16 Solenoid valve
17 Water meter
18 Compressed air line
19 Solenoid valve
20 Non-return valve
21 Spray nozzle, spray opening
22 Housing
23 Heating pipe
24 Drive motor
25 Rotor casing
26 Coupling piece
27 Deflection pipe
28 Pump

1. A steam generator for a baking oven, comprising:
at least one heat transfer element;
at least one water line which conducts water to the heat transfer element; and
at least one pressure increasing apparatus that increases the pressure of the water.

2. The steam generator as claimed in claim 1, wherein the pressure generating apparatus is a pump which is connected to the water line.

3. The steam generator as claimed in claim 1, wherein the pressure generating apparatus is a compressed air line that adds compressed air to the water.

4. The steam generator as claimed in claim 3, wherein the compressed air line opens into the water line.

5. The steam generator as claimed in claim 1, wherein the water line has a plurality of spray openings which are spaced from one another.

6. The steam generator as claimed in claim 3, wherein the water line is connected to a supply system, and a non-return valve is arranged in the water line between opening of the compressed air line and the connector to the supply system.

7. The steam generator as claimed in claim 1, wherein the water line is arranged substantially horizontally and above the heat transfer element.

8. The steam generator as claimed in claim 1, wherein the water line runs substantially vertically and laterally with respect to the heat transfer element.

9. The steam generator as claimed in claim 3, wherein the compressed air line is connected to at least one compressed air source which is one of the following: a compressed air cylinder, a compressed air supply system, and a compressor.

10. The steam generator as claimed in claim 1, wherein the heat transfer element is the following: heatable metal bars, heatable metal elements which are connected movably to one another, heatable steam iron elements, and a surface and/or a structural element within a baking chamber of the baking oven.

11. A baking oven, comprising:
a housing that forms a baking chamber;
a door coupled to the housing; and
a steam generator having at least one heat transfer element, at least one water line which conducts water to the heat transfer element, and at least one pressure increasing apparatus that increases the pressure of the water.

12. The baking oven as claimed in claim 11, wherein the heat transfer element is arranged in at least one of the following: the baking chamber, a chamber which adjoins the baking chamber, and a steam generating chamber which is connected to the baking chamber via at least one steam duct.

13. A method for generating baking vapor, comprising:
supplying water to at least one heat transfer element via at least one water line; and
guiding the water vapor which is produced into a baking chamber, wherein pressure of the water is increased.

14. The method as claimed in claim 13, wherein compressed air is added to the water.

15. A method for removing baking vapor from a baking chamber having a steam generator which is connected to the baking chamber and at least one water line and at least one compressed air line, comprising:
shutting off a water supply to the water line; and
opening a compressed air supply to the compressed air line.
